(19) United States
(12) Patent Application Publication
(10) Pub. No.: US 2004/0155603 A1
(43) Pub. Date: Aug. 12, 2004

(54) Direct current gas discharge lighting systems with arc suppression

(76) Inventor: John C. Clegg, Provo, UT (US)

Correspondence Address: Everett D. Robinson, Parsons Behle & Latimer, 333 South 520 West, Lindon, UT, 84042, US

(21) Appl. No.: 10/692,229

(22) Filed: Oct. 23, 2003

Related U.S. Application Data
(60) Provisional application No. 60/420,716, filed on Oct. 23, 2002.

(51) Int. Cl. H05B 39/00

(52) U.S. Cl. 315/291; 315/307; 315/308; 315/312

(57) ABSTRACT

Disclosed herein are gas-discharge lighting systems for supplying alternating current to gas discharge lamps such as fluorescent lamps, those systems utilizing a direct current distribution system. Also disclosed herein are such systems that include switches configured for interrupting the direct current, some of those including switch arc suppression. Detailed information on various example embodiments of the inventions are provided in the Detailed Description below, and the inventions are defined by the appended claims.

### CROSS-REFERENCE TO RELATED APPLICATIONS

This application claims the benefit of U.S. Provisional Application No. 60/420,716 filed Oct. 23, 2002 which is hereby incorporated by reference in its entirety.

### BACKGROUND

The claimed inventions relate generally to gas discharge lighting systems, for example fluorescent lighting systems, having a direct current distribution system, and more particularly to gas discharge lighting systems equipped with arc suppressing inverters for systems including direct current switches.

Some types of lighting systems utilizing a DC distribution system have been previously described in U.S. Pat. Nos. RE 33,057, 4,630,005 and 5,030,892, which are hereby incorporated by reference.

Very early high-frequency lighting systems used a single high-frequency generator which could be a rotating machine or large electronic inverter using vacuum tubes or thyratrons. High-frequency power from such a generator would be distributed throughout a building where simple and efficient high-frequency ballasts would be used to limit the current in each lamp or pair of lamps. Those high-frequency generators were very expensive, however only one was needed per building. Such systems worked and resulted in markedly reduced power necessary to drive fluorescent lamps, but only a few installations were ever made. Owners were justifiably fearful that failure of the central inverter would plunge their buildings into darkness for perhaps days before repairs could be made.

In older common fluorescent lighting systems, AC power is fed to a fixture containing a ballast driving one or two lamps. No inverter is required in this type of lighting system; the lamps are driven at the mains frequency, usually 60 or 50 Hz. These systems have at least four inadequacies. First, the lamps do not operate efficiently, as the arc is stopped and started 120 times per second. Second, the ballast, usually a large inductor, consumes a large percentage of the power of the consumed power, which heats the ballast often leading to ballast failure. Third, because the lights are driven at 120 Hz, strobing is sometimes visible, especially in the presence of televisions, computer monitors and other light-producing equipment. Fourth, because the inductors are fed with low frequency power, an audible and sometimes annoying hum is often produced.

With the advent of inexpensive power transistors, low-cost high frequency inverters could be made small enough to fit inside a casing the size of a conventional low-frequency magnetic ballast along with a ballast itself. A single-phase rectifier is also included in the package along with the inverter and the ballast, and the whole combination is now commonly called an electronic ballast. The rectifier converts the AC input at the mains voltage and frequency to a direct current power source, which is provided to the inverter. The inverter uses this DC input to produce an AC power source, at a higher frequency in the kHz range. Those lighting systems utilize a single phase AC power input, which indicates the use of large reservoir capacitors in the rectifier to smooth the DC output. To achieve the necessary capacitance at a reasonable cost, electrolytic capacitors are normally used. This capacitor is intended to reduce the lamp flicker or stroboscopic effect. The electrolyte in these capacitors evaporates over time, particularly in the heated space of the ballast enclosure, leading to ballast failure after typically 3 to 10 years. There is therefore little incentive to design other ballast components to exceed this lifespan.

The costs associated with ballast failure in fluorescent lighting are considerable. There is a first order cost of the ballasts themselves, and smaller contributing costs associated with the replacement of lamps and switches due to the failure of the ballasts. There is a redundant lighting cost, which includes the cost of power consumed by a failed lighting fixture and the cost of powering redundant lighting fixtures to ensure an adequate amount of available light. There is also a labor cost, as it is usually required to hire a skilled person to diagnose a failed ballast and perform the replacement procedure. For smaller buildings, the necessary equipment might include a small ladder and some hand tools. For larger buildings with high ceilings, such as warehouses or retail stores, additional equipment might be needed in the form of lifts or scaffolding. In most cases there will be a maintenance cost for this equipment. There is a further amortized cost of insurance and benefits, needed for persons servicing the lighting equipment who can be expected to suffer injury at a certain rate. A system having improved life and maintainability, particularly at the ballast and/or inverter, would therefore provide great benefit to both the owners and users.

Electronic ballasts have a significant efficiency improvement over magnetic ballasts. A typical lighting fixture can produce about 30 to 40 percent more light using electronic ballasts than magnetic ones. Even so, common electronic ballasts have a number of inefficiencies to be considered. First, in common fluorescent lighting systems, one rectifier/inverter pair is required per lamp or pair of lamps, adding to the installation and maintenance costs of the system. Second, because the rectifier utilizes single-phase power, a large capacitor is necessary in the rectifier to produce a smooth DC output. The use of this capacitor greatly decreases the power factor of the electronic ballast. Although a single ballast may not have an appreciable effect, those effects are more noticeable for installations of large numbers.

There is therefore a need for efficient gas-discharge lighting systems that utilize components with long lifespans.

### BRIEF SUMMARY

Disclosed herein are gas-discharge lighting systems for supplying alternating current to gas discharge lamps such as fluorescent lamps, those systems utilizing a direct current distribution system. Also disclosed herein are such systems that include switches configured for interrupting the direct current, some of those including switch arc suppression. Detailed information on various example embodiments of the inventions are provided in the Detailed Description below, and the inventions are defined by the appended claims.

### BRIEF DESCRIPTION OF THE DRAWINGS

FIG. 1 depicts a fluorescent lighting system having a DC distribution system.

FIG. 2 depicts a fluorescent lighting system having a DC distribution system, more fully showing the physical power distribution networks, also including DC switches.

FIG. 3 depicts in more detail a fluorescent lighting system with DC power distribution.

FIG. 4 depicts in detail another fluorescent lighting system with Dc distribution.

FIG. 5 shows a push-pull type gas-discharge lighting inverter.

FIG. 6a depicts a conceptual electrical model of an inverter circuit.

FIGS. 6b, 6c, 6d depict several variations on the circuit of FIG. 6a.

FIGS. 7a and 7b shows flyback voltage produced in a circuit as of FIG. 6a.

FIG. 8 depicts a circuit model with arc suppression on both switch opening and closing events.

FIGS. 9a, 9b and 9c show simulated performance of the model of FIG. 8 with several capacitor values.

FIG. 10 depicts another circuit model with arc suppression on both switch opening and closing events.

FIG. 11 depicts a rectifier circuit usable in disclosed direct current distribution lighting systems.

FIG. 12 depicts an alternate three-phase output lighting inverter.

FIG. 13 depicts another alternate poly-phase output lighting inverter.

FIGS. 14 and 15 depict advantageous ballast configurations.

FIG. 16 shows a switch having typical contacts and operation.

FIG. 17 depicts an improved transformer configuration.

Reference will now be made in detail to some embodiments of the inventions, example of which are illustrated in the accompanying drawings.

### DETAILED DESCRIPTION

The components of a building lighting system may be divided into two types. First, there is capital equipment having long life, installed with the expectation of not needing service for the life of the building. Examples of capital equipment are transformers, electrical panels, circuit breakers and wiring. The other type is consumable equipment, or equipment that can be expected to be replaced during the life of the building. Lamps and fluorescent ballasts are included in this type, as well as luminaires, sockets, switches, outlets, and fixtures and other visible equipment that may be desirable to modify the appearance of the lighting system. It is generally desirable to have the equipment of a lighting system in the type 1 category so as to approach, as far as is possible, a maintenance free system.

Some of the disclosed systems include several features, which will be described in detail presently. First, high frequency AC power is provided to lamps to reduce acoustic noise, reduce stroboscopic effect and increase lamp efficiency. Second, a reduced number of components are used. Where possible, components are used in common with several light fixtures. Third, where possible, components with low reliability are replaced with high-reliability equipment. In some of the disclosed lighting systems, the use of problematic electrolytic capacitors is eliminated entirely through the use of three-phase power, which can be rectified without large reservoir capacitors under many circumstances. Fourth, economy due to a reduced number of components and better efficiency and power factor. Fifth, the capability of using supplemental or alternate power sources, such as solar, wind, fuel cells, emergency battery banks, without requiring large modifications and/or equipment additions, such as inverters supporting grid feedback.

Disclosed systems are usable with various alternative energy sources. Including photovoltaics, or solar cells, into a direct current lighting system provide a very cost effective way to supplement energy sources. Solar energy is available especially in the middle of the day when air-conditioning loads are highest and when demand penalties may be assessed. In a large building with many interior rooms, the entire lighting system might be effectively and efficiently supplemented or powered entirely from photovoltaic energy captured on the building's roof. In a lighting system having DC distribution, this energy can be simply combined in parallel with the output of the lighting rectifier, which may naturally regulate the voltage. Without further instrumentation or regulation the lighting system draws from the electric utility only whatever energy is needed to make up the difference between that furnished by the photovoltaic cells and the lighting usage. A system may be designed such that regulators always supply some power from the utility company, by which the voltage of the distribution system may be maintained. The solar energy may be used economically when it is most needed, to reduce peak utility load and demand charges, without the expense of storing the energy or inverting it to low frequency.

Fuel cells, which by nature furnish a direct current, may also be used to supplement a DC distribution lighting system, and may also be used economically to reduce energy consumption during times of peak loading and for emergency lighting. Additionally, storage batteries might be added to a DC distribution lighting system. Those batteries might be charged at night or other low-cost off-peak times, which energy may be later be fed back into the lighting system during the peak load hours of the day when utility rates are high. Batteries may also be used for emergency lighting without the need for additional low-frequency inverters.

Wind turbines might also be used in some locations to provide power supplementation. Wind power is generally not available at all times. Battery storage may therefore be desirable in a wind-powered lighting system, which provides storage for energy usable at a time later than when it is generated. Of course, wind-generated power can be utilized at the time it is generated, providing an economical source of power without the need for batteries.

A flourescent lighting system with direct current distribution is advantageously adapted for use with incandescent lamps. Small low-voltage incandescent lamps are frequently used for atistic and for special effects. Transoformers are needed to provide the low-voltage, and the transfomers can be made very small and inconspicuous if they operate at the high frequency available in systems disclosed herein. Furthermore the direct current of some disclosed systems is distributed at mains voltage, 120 volts in the United States, and incandescent lamps can operate directly on such a direct power source if it is desired to supplement fluorescent lamps. Light-emitting diodes (LEDs) may also be advantageously used in a direct current distributed lighting system without DC to AC conversion, and the necessary inverter hardware, providing a reliable, economical and efficience source of lighting.

If a DC distribution lighting system is installed with an alternate power source, that system may also be tapped for alternate AC power through inverters to power to devices which are considered essential to keep operational, for example fire detection and alarm systems, computer servers, and security monitors and alarms.

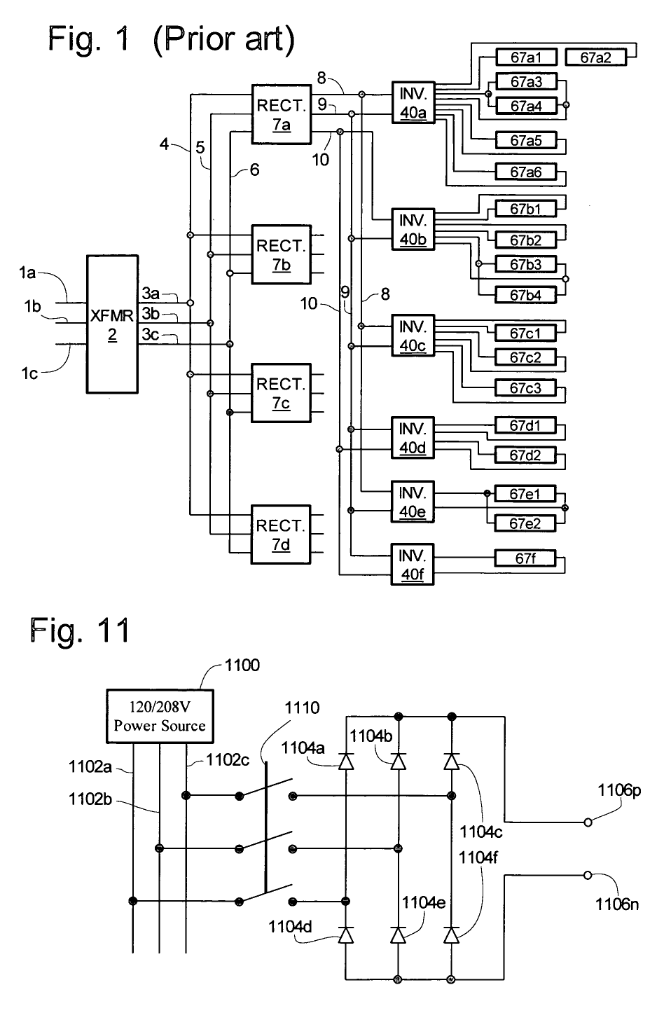

Shown in FIG. 1 is a fluorescent lighting system having a DC distribution system, previously disclosed in U.S. Pat. No. 4,508,996. The system obtains its power by a connection made at terminals 1a, 1b, and 1c of the primary of transformer 2, that power source usually being a commercially available source. In most countries of the world commercially sold power is generated and transmitted at low-frequency (50 or 60 Hz) alternating current and, in order to minimize I²R losses in transmission, it is stepped up by transformers to a much higher voltage than the output of the generator and then stepped down, usually in a succession of voltage reductions, to voltages deemed safe for the various parts of the transmission system from the main transmission line to the entrance to the customers premises. Usually this supply voltage is in the 110 to 480 volt range, which is considered a safe voltage for distribution in a building occupied by humans, such as a home, barn, shop, store, church, place of entertainment, etc. In many cases, particularly in recent years, power is brought to the customer's premises at a much higher voltage, especially where the building to be supplied is a church, school, commercial structure, or the like. In those circumstances it is a common practice to provide in or near the building a central transformer operating to reduce the supplied higher voltage to a voltage suitable for distribution through the building, of which transformer 2 is representative. If commercial power is available at the premises of the building at a suitable voltage, transformer 2 may be omitted.

The building distribution system shown, represented by lines 4, 5 and 6, is a three-wire circuit from the transformer 2 connected to the secondary winding through terminals 3a, 3b and 3c. Lines 4, 5 and 6 are connected to one or more rectifiers 7, which may be located at subcenters in the distribution system. The rectifiers receives low-frequency alternating current at the building voltage at the inputs and produces direct current output to its output side as three wire-direct current to lines 8, 9 and 10.

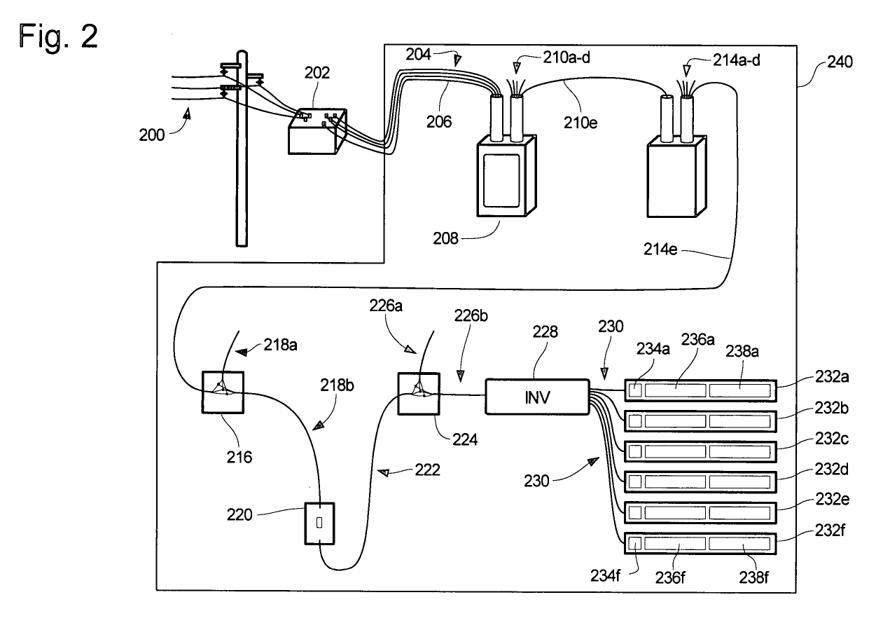

FIG. 2 depicts a typical DC distribution fluorescent lighting system at a logical level. 3-phase power is delivered to a consumer site by power lines 200. That power may be at a higher voltage than what is safely or conveniently carried into the consumer's building 240, in which case a step down transformer 202 converts the higher voltage to the desirable voltage, for example 208V. Main wires 204 carry 3-phase power at the lower voltage into building 240 to a distribution panel 208. A ground wire 208 is also normally provided for safety grounding in the building's electrical system. At distribution panels, shown by 208, power is distributed through cables 210a-e, which might, for example, be 3 phase or single-phase power. Circuit breakers or other overload protection would normally be included in the distribution panels. Shown in FIG. 2 is one particular distribution cable 210e providing power to a rectifier 212. Rectifier 212 produces DC power through cables 214a-e, in this example as single polarity power. Rectifier 212 may also include overload protection, which might be in the form of fuses, AC or DC circuit breakers, or other passive or active circuit interrupters. Cable 214e feeds through protected spaces in building 240 to junction boxes 216, by which power may be distributed to various circuits in the building. Shown in the drawing are two circuits, 218a and 218b, both feeding DC powered lighting circuits. Cable 218b feeds into switch 220, which provides means of interrupting the power to the circuit fed by cable 222. As desired, additional junction boxes, for example 224, may be used to connect lighting power to inverters, for example 228, through cables 226a and 226b. Inverters in this system supply high frequency AC power to several lighting fixtures, 232a-f, through cables 230, each lighting fixture containing a ballast 234 and two lamps 236 and 238.

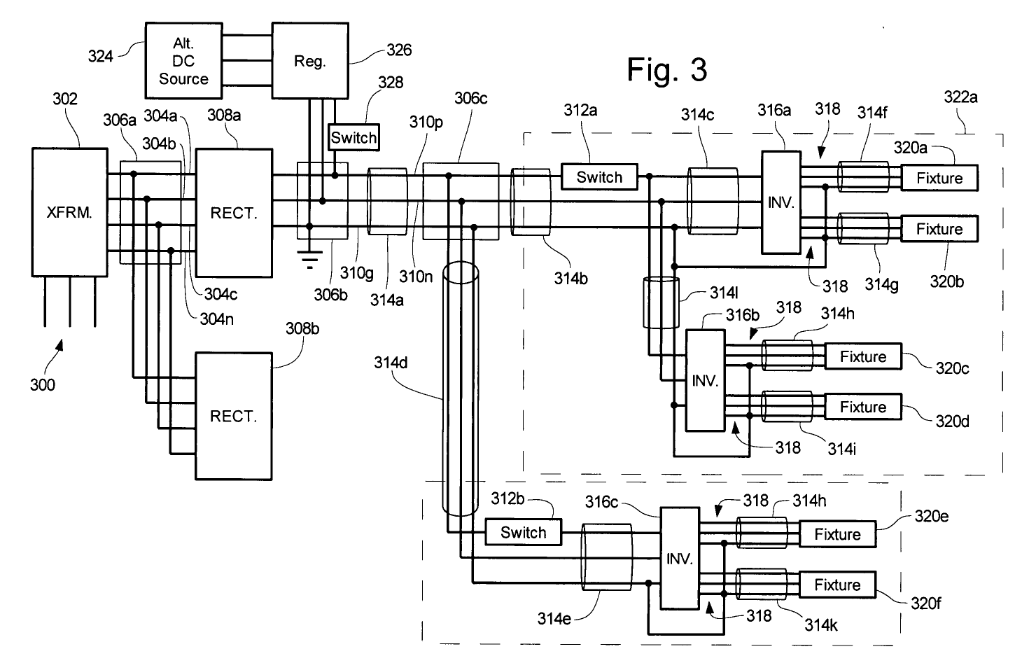

FIG. 3 provides a more detailed illustration of a fluorescent lighting system with DC power distribution. In this example, 3-phase power is fed into transformer 302 through distribution wires 300, the transformer providing electrical isolation and/or a step down in voltage. The output of transformer 302 is, in this example, also three-phase power, which is fed through wires 304a-c carrying voltage of three phases and neutral wire 304n to rectifiers 308a and 308b. Rectifier 308a converts the three phase AC power to single polarity DC power produced at distribution wires 310p (positive), 310n (negative) and 310g (safety ground). Connections may be made at electrical boxes, 306a-c, as is common practice in standard AC wiring, to provide protection from accidental electrical shocks. In this example, DC power is provided to two branch circuits at box 306c to two lighting areas 322a and 322b, which might be, for example, a room and a smaller lighted closet.

For each area, a switch 312 may interrupt the flow of current through the positive DC distribution wires 310p, providing a way to energize and de-energize inverters 316a-c. Switches 312 may be located as desirable, for example near entryways at four feet from a floor, and will normally be enclosed in an electrical box. Switches 312 should be selected based on safety and lifespan under the expected conditions of use and for DC power. Normal AC rated switches can sometimes be used, although the lifespan of those switches may be greatly reduced if measures are not taken to suppress arcing at the switch. Inverters 316 convert incoming DC power to AC power for delivery to lighting fixtures 320, the AC power preferably being at high frequency. Distribution wires 310 outside of electrical boxes 306, fixtures 320 are contained in cables 314a-1 providing a standard protection against accidental contact with current conducting wires. AC rated cables may be used for cables 314, while observing the manufacturers recommendations for AC voltage and current. In the example of FIG. 3, standard 14/2+ ground NM type cable would be an appropriate choice for some installations for cables carrying DC distributed current and 16/2+ ground NM cable for carrying high-frequency AC current to fixtures. If AC rated cables are used, it is likely desirable to mark or distinguish them from other cables in an electrical system so as not to confuse the two. Such a distinction might be made by a different insulation or sheathing color, a marking at each junction box, or other method as desired.

In the example system of FIG. 3, an alternate power source is provided for either emergency or supplemental power to the lighting system. An alternate DC power source 324 produces or stores power independently of power supplied at distribution wires 300. Power source 324 might be, for example, batteries, solar cells, a fuel cell, a diesel generator, a wind powered generator, or any other source of DC power. That power is optionally delivered to a regulator 326, which may regulate power delivered to the DC distribution network 310 at a set voltage or voltage range, and otherwise prevents power from being consumed by the alternate power source should that source voltage fall below the network voltage at 310p. Regulator 326 may be a switching-type regulator, provided it operates as a sufficiently high frequency to prevent voltage fluctuations from affecting the other components of the distribution network. If the alternate source is to be delivered to other DC distribution networks, a separate regulator can be used to isolate the networks from each other. In that event, it may be desirable to utilize rectifiers 308 and regulators 326 in a common package. Switches 328 may also be included to connect and disconnect the alternate power source from the network. Other alternative energy sources may be used in disclosed systems, in methods disclosed and other methods.

In one example, DC source 324 produces power at a somewhat higher unloaded voltage than that produced by rectifier 308a, providing supplemental power to the lighting system. In another example, regulator 326 and rectifier 308a are coupled such that power is delivered solely through regulator 326 if that power is sufficient to operate the DC distribution network, with rectifier 308 supplying supplemental power as needed.

In one example, source 324 is solar-voltaic cells. In that example, regulator 326 may be omitted, as solar cells do not generally conduct when reverse-biased. One or more diodes may be included to limit any reverse-biased leakage, if desired. This configuration is exceptionally economical, as no intermediate inverters, synchronizing or regulating equipment is needed to utilize the output of the solar cells, and therefore conversion losses are minimized in those systems. Solar cells may be connected in series to generate a sufficiently high voltage to supplement rectified source, which cells then produce energy directly and efficiently into the lighting system.

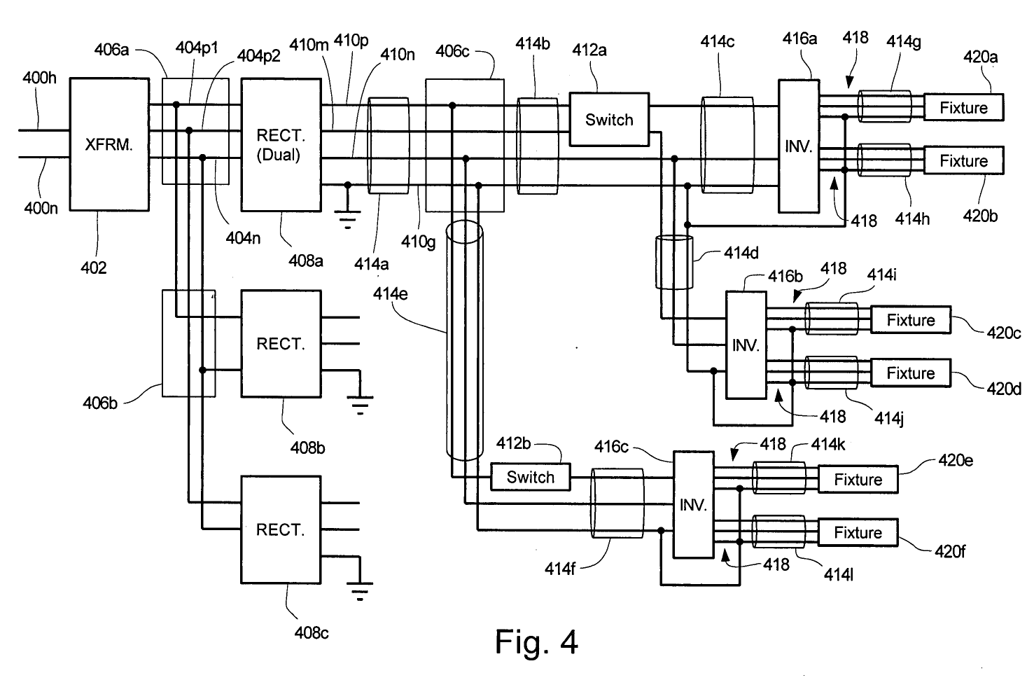

FIG. 4 depicts a similar system as that of FIG. 3, with a number of differences. First transformer 402 is fed from a single phase AC source through wires h and 400n. The secondary winding of transformer 402 is configured to produce AC power in two phases on lines 404p1 and 404p2 relative to neutral line 404n separated by 180 degrees. Rectifier 408a provides full wave bridge rectification and produces DC power in two polarities on distribution wires 410p (positive) and 410m (minus) in relation to return wire 410n (neutral). A safety ground 410g is also provided. Rectifiers 408b and 408c are connected to separate phases from transformer 402, with the intent to balance the load on both phases of the transformer. Rectifiers 408b and 408c provide single polarity DC power to loads not shown. Because DC power is distributed in a positive and negative polarity through wires 410, a three-conductor cable is not sufficient for some portions of the distribution network. In this example, both polarities are carried through cables 414a and 414b, but only one polarity is necessarily carried by the remaining cables after which only one polarity is maintained. For these cables, a four conductor cable is used, for example 14/3+ ground NM type cable. At switch 412a the network separates polarities for two inverter circuits, for which a three-conductor cable is used. Switch 412a is a double-pole single-throw type to switch both DC power polarities. The branch from box 406a continuing to switch 412b maintains a single polarity, and thus requires only a single-pole single-throw switch. Although an unbalanced circuit, with respect to DC polarity, is shown in FIG. 4 for brevity, it will generally be desirable to balance loads between polarities such that stress on components internal to the rectifiers will be minimized.

Now although the above examples show and describe systems fed by three phase or single phase power, those system types may be fed with either single phase, three phase or other configurations of electrical power, as appropriate for the particular location and/or use, as will be understood by those skilled in the art. Preferably a rectifier is fed by three-phase power, as in many cases a reservoir capacitor is not needed to produce direct current with an acceptable amount of voltage deviation.

Switch Arcing

To date, fluorescent lighting systems utilizing a DC distribution system are few and not well understood. Some prototype systems have yielded some understanding, but an experience base of the operation of those systems over a period of years is only now being developed. In the construction of the prototype systems, the lighting system was turned on or off through the use of circuit breakers interrupting the AC feeding the DC rectifiers, or through the use of heavy duty or motor rated switches. Although interruption using AC circuit breakers is useful for some installations, for example in warehouses, it is not adequate for buildings divided up into spaces, for example office buildings, where it is desirable to provide a switch for the occupant's control and convenience. Prototype systems have shown typical DC rated switches to have a lifespan of about ten to fifteen years, due in general to surges of power at turn-on and arcing at turn-off. These and other heavy duty switches can be used, if the switches are regularly replaced, perhaps every five to ten years, however a lighting system supporting a longer switch life is highly desirable. Where occupancy sensors are used, arc prevention is especially important to extend the life of relays and thereby those sensor units.

In FIG. 16, a switch having typical contacts and operation is depicted. The switch is comprised of two side walls 1602 and 1604. The side walls contain features for restraining a rocker 1600 and a flexible metallic assembly 1612. Rocker 1600 pivotably mounts in apertures 1606 and 1608 through the reception of two trunnions, one of which is shown as 1610. Two contacts 1618 and 1620 are provided to open and close the switch, contact 1620 being fixed and contact 1618 mounted on assembly 1612. Assembly 1612 has an upper portion 1616 which flexes in relation to the lower portion 1614. The rocker contains a mating feature by which upper portion 1616 may be forced to flex, thereby either separating contact 1618 from contact 1620 or bringing those contacts together.

In the operation of the switch of FIG. 16, contacts 1618 and 1620 are moved through a force applied to the rocker 1600. For closing the switch, rocker 1600 is depressed. A resistive force is normally designed into the switch so that a certain amount of force or torque must be applied before the internal parts of the switch will move. Speaking of the switch of 16, movement of the rocker 1600 causes upper portion 1616 to flex, and causes contact 1618 to approach contact 1620. When the contacts approach within the dielectric breakdown distance of the air, for example about 0.6 mm for 170V, current may begin flowing through an arc between the contacts, if a low-impedance load is connected to the switch. Movement of upper portion 1616 continues until contacts 1618 and 1620 make physical contact, after which arcing does not generally occur. Movement normally then continues further to create a tension to hold the contacts together.

For opening the switch, rocker 1600 is again depressed, although on the opposite side. Upper portion 1616 flexes the other direction, which causes the contacts 1618 and 1620 to move apart. Movement of upper portion 1616 containues until a small gap appears at the contacts. An arc will generally appear between the contacts for all cases, although the arc may be small. The presence of the arc will cause a certain amount of ionization of the air between the contacts, which tends to lower the electrical resistance between the contacts and extend the life of the arc. Arcing continues until the gap between the contacts 1618 and 1620 is sufficient to overcome the voltage applied thereto. If the switch is applied to a resistive or capacitive load, the voltage between the contacts does not generally become greater than the maximum source voltage of the circuit, which is about 170 volts for 120 VAC circuits. An inductive load, however, may generate high voltage potentials at the switch which results in increased arcing between the switch contacts.

Now in ordinary switches, the maximal distance between open contacts is usually small. In the switch of FIG. 16, the maximal separation might be about 0.25 inch or 5 mm. Additionally, the time to move the switch and contacts from open to close, and vice versa, is usually a relatively long time of perhaps 1/20^{th} or 1/100^{th} of a second in relation to the speed of typical electrical events in a circuit. An ordinary switch may, therefore, retain the contacts in close proximity, close enough to arc, for 10-20 milli-seconds, which can be long enough to damage a switch in repeated use if large-current arcs are experienced.

Speaking generally, switches fail due to either mechanical wear or the oxidation (burning) of the contacts due to arcing. With sufficient oxidation buildup, a switch may be found to have an intermittent connection or complete prevention of electrical contact. Furthermore, each arc may cause a small amount of contact metal to vaporize, which wears away the contact over repeated use of the switch. In extreme cases, contacts may be reduced over time such that they may not mechanically be made to contact.

Arcing problems are generally exacerbated in direct current over alternating current circuits. First, arcs are shorter-lived for alternating current, because the current flow is interrupted often, for example every 8 milliseconds in a 60 Hz AC system. The ionized air between the contacts may be displaced during these interruptions, which will extinguish an arc if the contacts have reached the critical breakdown separation. Additionally, with each arc, metal tends to migrate from one contact to the other through ionization, which maintains a direction relative to the current flow. Because current flows in both directions in alternating current circuits, the deposition tends to be evenly deposited on both contacts, and thus the problem is rarely noticed. In direct current curcuits, the contacts are generally always polarized, leading to deposition on one contact and erosion at the other. The deposition and erosion tend to occur in a pattern, for example at the center of the contacts, which can lead to localized heating, burning and vaporization of the contact metal.

In the prior art, methods have been used to mitigate contact burning and wear. These methods have included the use of special contact alloys, for example silver alloys, and the use of larger contacts which wear more slowly. Where solutions at the switch do not work, the circuit load may be designed to have less inductive load at the switch, or the switch may be scheduled to be regularly replaced and made a maintainence issue and expense. In some circumstances, mercury switches are useful to avoid arcing problems, as although an arc may be experienced in a mercury switch, the mercury is enclosed in a container and does not oxidize or vaporize away. The use of mercury switches has been discouraged in recent years, due to the hazards of mercury poisoning should the switch enclosure ever leak or fracture.

In direct current lighting systems, an inductor is often needed in the inverter circuit, which exposes the switches to large flyback voltages and potential arcing. Common AC lighting systems, on the other hand, use switches to interrupt the AC current before rectification. Any flyback voltage is thereby absorbed by the rectifier before it can reach the switch. A solution for arcing in the switches of a DC distributed gas-discharge lighting system is therefore both desirable and called for.

Inverters

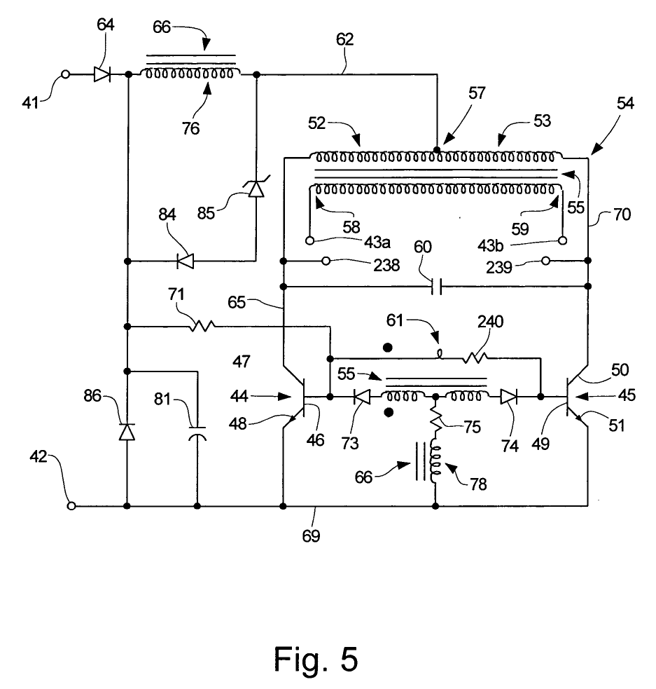

An inverter as disclosed in U.S. Pat. No. RE. 33,057 is suitable for use in fluorescent lighting systems utilizing a DC distribution network, some of that inverter disclosure being reproduced here. Referring now to FIG. 5, an inverting means comprises a positive input terminal 41 and a negative input terminal 42. These terminals, 41 and 42, are adapted to be connected to the direct current lines from a rectifier, battery, solar cell, or other source of direct current power. On the output side of the inverting means 40 are two terminals 43a and 43b for the high-frequency current generated in the inverting means 40 by the means now to be described in detail. The inverter means 40 utilizes two transistors 44 and 45 which are the active elements of a high-power, push-pull, class-B, tuned-collector, current-driven oscillator. An oscillator of this sort, intended to produce a large amount of AC power from a DC source, is commonly denominated in this art as an inverter and that name is generally used herein for such elements of the circuit of the invention. Transistor 44 has a base 46, a collector 47 and an emitter 48. Transistor 45 has a base 49, a collector 50 and an emitter 51. The tuned circuit comprises inductors or windings 52 and 53 of an inverter transformer 54 which has a magnetic core 55, e.g., a ferrite core. Windings 52 and 53 have a common center terminal 57 and end terminals 58 and 59. A capacitor 60 is connected to the end terminals 58 and 59 which in turn are connected to collectors 47 and 50 by lines 65 and 70, respectively. This circuit is preferably tuned to oscillate or resonate at a frequency of 10-100 kHz, and preferably at least 20 kHz, in order (1) to enhance the efficiency of fluorescent lamps, (2) to be inaudible and (3) to make possible the utilization of small and practically loss-free circuit components. Collector inductors 52 and 53 are wound on the magnetic core 55 of transformer 54, along with other windings which are described hereafter. In operation, a high AC voltage of sinusoidal waveform appears across the end terminals 58 and 59 of inductors 52 and 53. A feedback winding 61 is provided on core 55 and by transformer action a much smaller voltage is induced in it than in windings 52 and 53 because of the small number of turns it has. The end terminals of feedback winding 61 are connected respectively to bases 46 and 49 of the transistors 44 and 45. The polarity of the feedback voltage is selected to provide positive feedback from collectors to bases as required to maintain or sustain oscillation. The transistors operate in an efficient alternate switching mode, one being turned off completely at one instant while the other is saturated at which time it is turned fully on and is equivalent to a closed switch. The feedback signal to the bases causes switching from one state to the other. The transistor with the more positive base voltage is saturated or in the “on” state. The transistor with the more negative base voltage is in the “off” state. A brief transitional interval is required to complete switching from one state to the other.

Direct current flowing into the inverter enters at the positive terminal 41 which is connected by conductor 62 to the center terminal 57 of windings 52 and 53 through a fuse (not shown), a diode 64 and an inductor and winding 76 on a magnetic core 66. At the central terminal junction point 57 the current must take one of two alternate paths. One path comprises inductor or winding 52, terminal 58, line 68, collector 47, emitter 48 of transistor 44, line 68 and line 69 which returns current through terminal 42. The current takes this path when transistor 44 is in conducting mode. The other path which the current takes, when transistor 44 turns off and transistor 45 turns on, comprises winding 53, terminal 59, line 70, collector 50, emitter 51 of transistor 45, line 69 and terminal 42, thus returning the current along this second path. Current flowing alternately through windings 52 and 53 of transformer 54 produces an alternating voltage in every winding on the core 55, which is the desired result of the action of the inverter.

Transistors can generally turn on more quickly than they can turn off. Consequently, one transistor will turn on before the other transistor has turned completely off. This results in an actual short circuit across the terminals 58 and 59 of the windings 52 and 53 for a brief interval at each switching time. This short circuit is rendered harmless because inductor 76 maintains an essentially constant current through itself and associated parts of the circuit and thus prevents the transistor collector currents from rising appreciably during the short circuit or conduction overlap period. The transistors thus start and complete their switching actions under ideal conditions of practically zero collector voltage and externally limited collector current.

Resistor 71 conducts a small current from the positive DC input terminal 41 to the bases 46 and 49, respectively, of the two transistors 44 and 45 by way of feedback winding 61. This is the only source of base current when the inverter is first turned on and is included for reliable starting. As oscillations build up, most of the base current comes from voltage induced in the feedback winding 61, as will be described in more detail hereafter.

Diode 64 is optional and, when used, prevents the a reverse current if the input terminals 41, 42 are incorrectly connected to a power supply. Diode 73 connects the base 46 of transistor 44, and diode 74 connects the base 49 of transistor 45, the line 69 through resistor 75. Diodes 73 and 74 are connected one at each end of the feedback winding 61, rather than having a single diode at the center tap. This doubles the voltage available for rectification and allows stable operation down to such low input line voltages that the transistors are adequately protected for all low voltage conditions.

Inductor 78 is not always required. However, when used, it can reduce peak base current and reduce the power dissipated in resistor 75. For economy, inductor 78 a few turns of wire around the core 66 of inductor 76, and connected in series with resistor 75. This causes current to flow from diodes 73 and 74 through resistor 75 and winding 78. Transformer action from the main inductor winding 76 then induces the same voltage in these few turns 78 without the expense of an additional magnetic core and bobbin. Winding 78 adds an AC voltage at the bottom of resistor 75 equal to the AC component of voltage from feedback winding 61 at the top of resistor 75, leaving only a DC voltage across resistor 75, resulting in a constant base current.

Diode 84 and Zener diode 85, when used, are arranged in series with each other and across inductor 76, as shown, to limit the maximum positive voltage that can be applied to the transistor circuit. A dangerous voltage capable of destroying the transistors can otherwise occur during externally applied line voltage surges.

A diode 86 may be placed across the DC input lines. This diode conducts only for an instant when the DC input power is switched off. It provides a controlled path for decay of the current stored in inductor 76 when that current can no longer flow through the input line 62. Diode 86 also reduces arcing at the switch (not shown) which turns off the DC input voltage (although it does not eliminate arcing entirely, as discussed below). Diodes 84 and 86, Zener diode 85 and capacitor 83 comprise transient suppression circuitry.

The AC output of the inverter can be used in many ways. One, two, three, or more, “rapid start” fluorescent lamps can be driven. These lamps have electrodes in the form of filaments at each end thereof, which must be heated by a flow of current produced by means of a low voltage. The heater voltage for the filaments may be obtained from low voltage heater windings on magnetic core 55. Filaments at the opposite end of each lamp require separate heater windings on the same core. Fluorescent and other gas discharge lamps have a negative impedance characteristic which makes direct parallel operation impractical. Each lamp, pair or group of lamps requires a ballast impedance in series to limit the current. Either inductors or capacitors can perform the ballast function without wasting energy, particularly if driven at high frequency. Windings 52 and 53 constitute a sinusoidal high voltage, high-frequency power supply for the lamps. The voltage of these windings is determined almost completely by the DC input voltage to the inverter, but the voltage applied to the lamps can be selected independently by tapping one or both of the windings 52 and 53 for lower voltage. A higher voltage can be obtained by extending either or both windings with additional turns (not shown) beyond the points where the transistor collectors connect. An entirely separate winding (not shown) on core 55, of any desired voltage, can be used for the lamps and with full transformer isolation, if necessary or desirable.

Other similar inverter circuits are shown in U.S. Pat. No. Re 33.057, which circuits and others may be substituted in systems disclosed herein. The circuit of FIG. 5, and similar circuits, provide an inverter capable of driving the relatively high loads of fluorescent lamps and ballasts, while requiring a modest number of components at a reasonable cost. That basic inverter design is therefore considered highly suitable for wide use in various applications and systems, disclosed herein and otherwise.

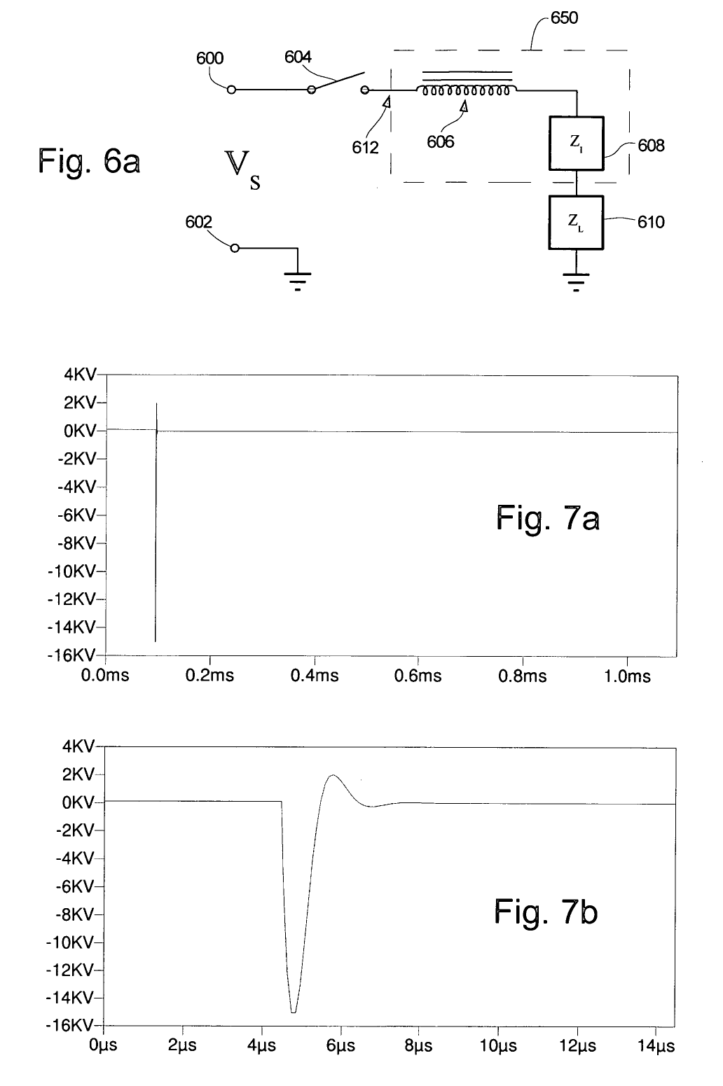

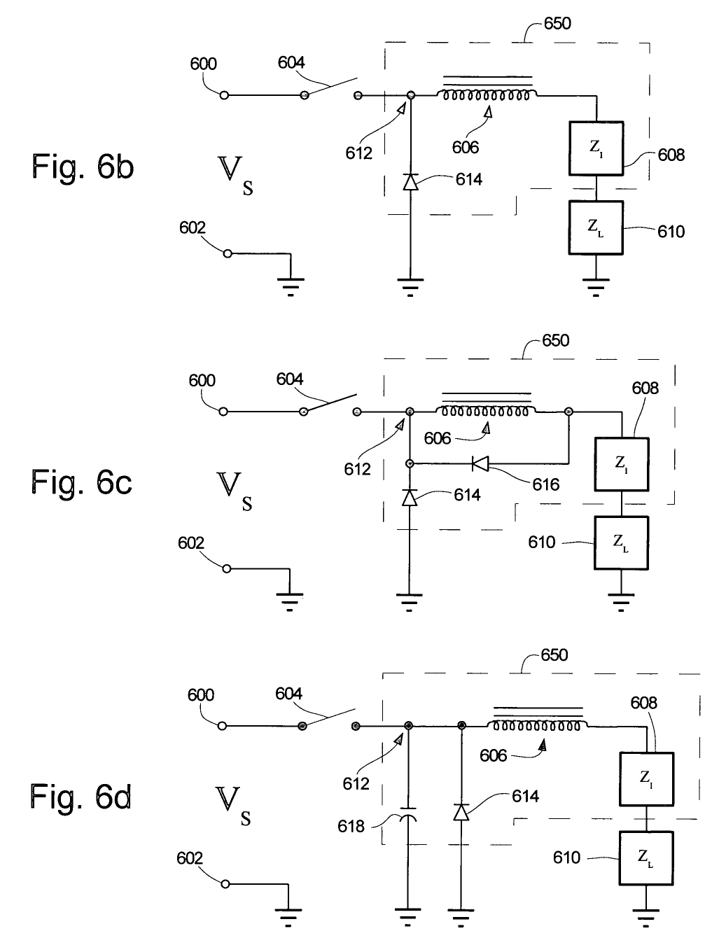

A conceptual model of an inverter of the type of FIG. 5 is depicted in FIG. 6a. A DC voltage V_{S} is applied between terminals 600 and 602, which for this discussion will be 120 volts. A switch 604 provides means to energize and de-energize inverter 650, which includes inductor 606 and a load 608. Inverter 650 provides AC power to a lighting load 610, which would normally include at least one ballast and lamp.

The use of inductor 606 has both a positive and negative effect as will now be disclosed. When the inverter circuit 650 is energized by closure of switch 604, a large potential can appear at the switch contacts just before closure, particularly if the impedance of the inverter is of a resistive or especially a capacitive nature. In inverter circuits other than of the type of FIG. 6a, an in-rush of current occurs due to the charging of capacitors and initial conduction of transistors. Inductor 606 does not immediately conduct current when a voltage first appears across it, which prevents an arc from starting at the switch contacts when the switch 604 is closed. Inductor 606 has the opposite effect when switch 604 is opened. Inductor 606 continues to conduct a current for a time, producing a flyback voltage and potentially producing a large voltage across the switch contacts resulting in an arc. The use of an inductor in an inverter, especially as a constant current source or filter, may therefore cause undesirable arcing at the switch contacts.

For a more clear understanding, FIG. 7a depicts the flyback voltage produced at the switch contacts, ignoring the effects of an arc discharge, as produced in a simulated circuit. For this simulation, inductor 606 was given a value of 12.6 millihenries, and a load was placed between point 612 and ground of 10 megohms and 5 pf stray capacitance. FIG. 7b shows a close-up of the flyback event.

Now the reader will note that the flyback event will vary depending on the inductor used, as well as the stray loads of a particular inverter. Although the maximal voltage in this simulation was about 15 kV, much higher or lower values might be encountered in a real system. Also note that the maximal voltage is generated within a few microseconds of the opening of the switch.

In order to form an arc between the switch contacts, a voltage must be generated which exceeds the breakdown voltage of the air for the distance between the contacts at any particular time. When a switch is depressed to be opened, there is a period of several milliseconds during which the contacts are opening, but have not yet achieved an appreciable distance between them. During this time the switch is particularly vulnerable to arcing. A typical arc event starts in the first few microseconds after the switch contacts open. A voltage of up to several kV is generated, which causes an arc to start between the relatively close switch contacts. Once the arc is started, it continues through the period of magnetic collapse of the inductor until the flyback voltage is reduced to a sufficiently small amount. Because the arc allows current to flow through the inductor, the arc event is extended many times, as the inductor produces the flyback voltage for a longer period of time, although at a lower voltage and a slower rate of magnetic collapse. The extension of the arc is particularly damaging to the switch contacts.

Improved Arc Suppressive Circuits

FIG. 6b depicts an improved inverter circuit, including a diode 614 between point 612 and ground. This diode prevents point 612 from having a potential significantly below ground. Referring again to FIG. 7b, while the magnetic field in inductor 606 is collapsing, a negative voltage at point 612 occurs with respect to ground. When point 612 reaches a negative diode voltage drop potential, diode 614 begins to conduct and continues until the current in inductor 606 ceases, preventing point 612 from dropping more than about one volt below ground potential.

Although the circuit of FIG. 6b may reduce the arc at the switch contacts, it does not stop an arc from forming. Within a few microseconds after switch 604 is opened, the voltage across the contacts becomes V_{S}, or 120V.A potential of 120V can arc across a gap of approximately 0.016 inch, or about 0.4 mm. Because the switch contacts cannot physically move apart rapidly enough to achieve that separation before the contact voltage builds, an arc will form. The circuit of FIG. 6b is therefore not preferred.

The circuit of FIG. 6c adds diode 616, which prevents a negative voltage buildup across the inductor. This technique is sometimes used to prevent arcing in motor brushes. This doesn't work in this application for two reasons. First, the voltage at 612 is not affected: point 612 is still permitted to quickly go to ground potential after switch 604 goes open. Second, diode 616 defeats the function of inductor 606 as a constant current source: at times when less current is drawn from inductor 606, the voltage at Z_{I} 608 will tend to remain steady rather than rising. The circuit of FIG. 6c is therefore also not preferred.

FIG. 6d adds a capacitor 618 across point 612 and ground, which adds an improvement to the circuit. As switch 604 opens, capacitor 618 provides a current reservior for inductor 606 to draw on, by which the voltage at 612 collapses more slowly. If a capacitor is chosen with sufficient capacity, the voltage across the contacts can now be maintained close to zero while they are close together. Capacitor 618, however, adds to the in-rush current of the circuit when first energized, which may cause arcing in the switch at that time. That arcing event may not be in the form of a spark, but rather a transient of perhaps a few microseconds conducted through a relatively small spot on the switch contact surfaces before full contact is made. Because that transient is carried only over a small spot on the contacts, the current density at that spot can be high. The contact metal can become heated leading to burning or vaporization of the contact surfaces. FIG. 6d, although providing improved anti-arc performance, is therefore not a preferred solution.

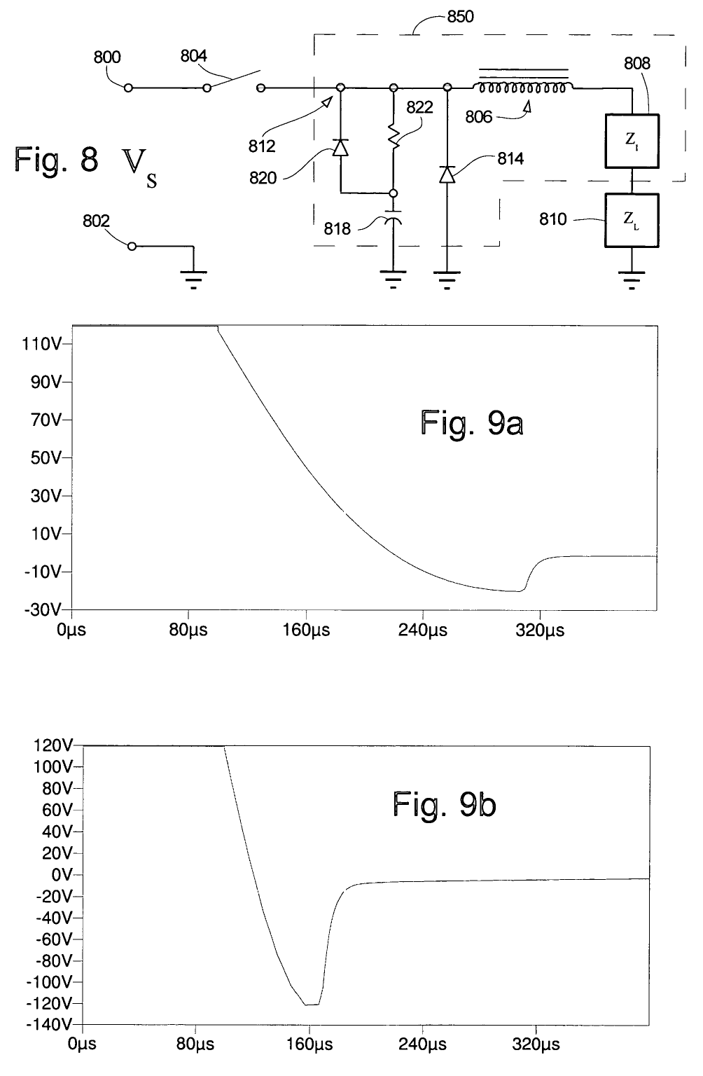

FIG. 8 illustrates a circuit which provides good arc suppression both at switch opening and closure, while utilizing a few additional components at a modest cost. In this circuit, a capacitor 818 is retained from the circuit of FIG. 6d. Resistor 822 provides a trickle current to charge capacitor 818 to V_{S}. Resistor 822 should be selected to have a small enough resistance such that capacitor 818 is likely to be charged when a person next opens switch 804, while being large enough to suppress the arc that otherwise would be formed to charge capacitor 818. In one example inverter, inductor 806 has a value of about 10 to 100 millihenries, resistor 822 has a value of 100 kilohms, and capacitor 818 has a value of 0.1 microfarad. A diode 820 is also added to conduct a charge stored in capacitor 818 to the inductor 806 and slow the rate of voltage potential increase across the contacts of switch 804. As the duty of diode 820 is infrequent and very short, it may be a small signal type diode, and is preferably selected to have a reverse breakdown voltage substantially above that of Vs to maintain the desired behavior under adverse conditions.

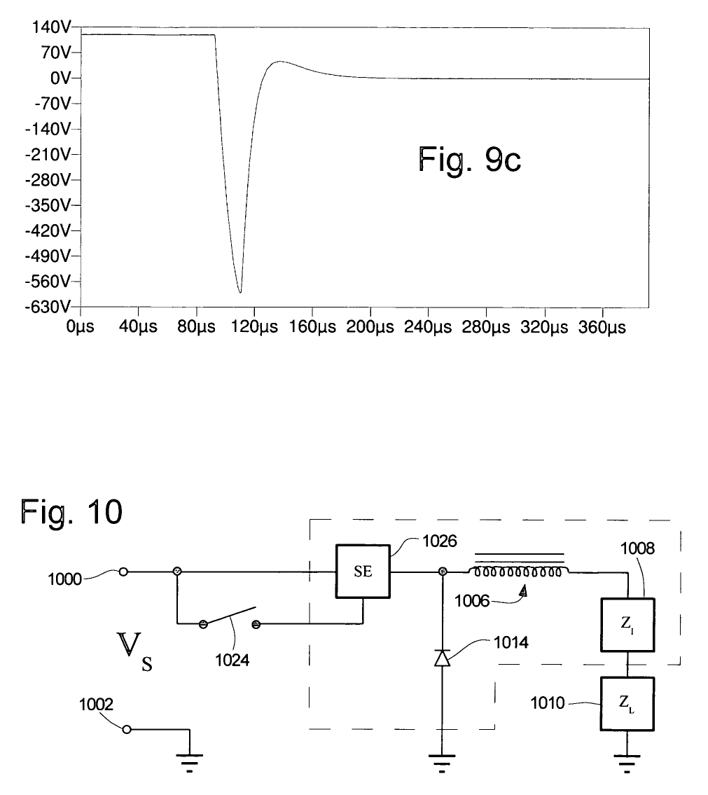

FIGS. 9a, 9b and 9c illustrate the simulated performance of one arc suppressing inverter. That inverter utilizes a circuit similar to that of FIG. 8, with the exception that diode 814 is omitted to fully show the effect of capacitor 818 on the potential voltage at the switch contacts. In that circuit, inductor 806 has a value of 12.6 millihenries, and the combined Z_{I} and Z_{L} is 192 ohms, as in the simulated circuit of FIG. 7. For FIG. 9a, capacitor 818 was chosen to have a value of 0.47 uF. This value is very effective, in this case, causing the voltage decline to slow from a rate of about 30 kV per microsecond to a rate of about 1.5 volts per microsecond. The capacitor 818 is sufficiently large that diode 814 would not have an appreciable effect, if included. The circuit of FIG. 9b uses a 0.1 microfarad capacitor, which results in a faster voltage decline and a substantially large negative voltage spike. FIG. 9c shows behavior of the same circuit with a 0.01 microfarad capacitor.

If desired, the following procedure may be used to select the components in a circuit of the type of FIG. 8. First, a velocity of contact separation is determined. The velocity of contact separation is particularly important for the period starting the instant after the contacts no longer make electrical contact, continuing until the contacts have reached a particular separation. The end of the period may be chosen to be the time the contacts are sufficiently separated such that the voltage V_{S} is too small to start an arc, for example about 0.6 mm for a V_{S} of 170V. That velocity determines a maximal breakdown voltage slew rate, or dV/dt over that period, which may be determined by using the breakdown voltage of air, about 3×10⁶ V/m. A capacitor 818 is then chosen with sufficient capacitance to slow the slew rate below the maximal breakdown voltage slew rate. Preferably, a capacitor with a larger value is chosen to avoid component variation, for example various types of switches and expected variations in the value of inductor 806 and capacitor 818. Preferably a much larger value capacitor may be used, especially where the cost of the larger capacitor is negligible over the cost of a smaller capacitor. The use of non-electrolytic capacitors is preferred for long inverter and switch life. More particularly, ceramic capacitors may be advantageously used due to characteristics of long life, high breakdown voltage and low cost.

More specifically, the value of the capacitor 818 may be determined as follows. First, a maximum current I is determined for the inductor 806. The equation C=I/(dv/dt) may then be used to calculate a minimum capacitance.

Now it will not always be practical to determine a velocity of contact separation. That value may also be estimated. If estimated, it will be desirable to test the circuit on samples of switches to be used. Likewise, a capacitor may be selected by experimentation using a goal of arc suppression, for example no observable arcing or a measure of contact oxidation or erosion per number of switch events.

Similar methods of selecting voltage slewing slowing components may be used for other circuit configurations, particularly by slowing the voltage slew rate across the switch contacts to prevent arcing therein. If desired, a larger capacitor may be used without the need of a clamping diode, such as 814 in FIG. 8, to prevent the contact potential from dropping below zero. In that case, the capacitance should be chosen such that the stored energy approaches or exceeds the energy stored in the inductor when the circuit is de-energized.

FIG. 10 illustrates an alternate arc-suppressing inverter. A DC power source is provided at terminals 1000 and 1002. A switching element 1026 provides a gate for current delivered to the rest of the inverter circuit, in this example at inverter 1006. Element 1026 is controlled through a relatively high impedance input, in this example the input being tied to a switch. Element 1026 might be, for example, a bi-polar transistor having a high breakdown voltage and sufficient current carrying capacity. Element 1026 might also be a relay, FET, or other switching device. If an FET is used, additional circuitry may be required to provide appropriate voltage levels at the gate of the device, and may also require a pull-up or pull-down resistor to provide a known state when the switch is open. A diode 1014 is provided to prevent the voltage at the inductor from going significantly lower than ground.

In the circuit of FIG. 10, inductor 1006 provides a constant current source for the inverter, and further isolates fluctuations in load Z_{I} from the power supply. Inductor 1006 may be omitted if the switching element 1026 is designed to provide an equivalent constant current. In one example, switching element 1026 is a bi-polar transistor, having a known input current at the base adjusted for the beta of a particular transistor. In another example, switching element 1026 is a chopping circuit using an FET operational amplifier, sensing the current delivered across a resistor of low value. In those examples, a flyback voltage is avoided due to the absence of inductance in the front-end of the circuit. It is possible that other inductors in the circuit may cause flyback to propogate back to the switching element, and a skilled practitioner will design the switching element to compensate. One skilled in the art may design other constant current sources, which are considered within the scope of the invention.

Now as the circuit of FIG. 8 requires only a few passive, inexpensive components and the circuits of FIG. 10 require active and more expensive components, the solutions of FIG. 8 are considered preferred.

Including arc suppression at the inverter has an important advantage, in that no additional means are necessary to control arcing in the entire lighting system. Were arc suppression to be included in the switches, the arc suppression would dictate a maximum number of inverters that could be switched before being overpowered by surges and flyback events. Because the circuit of FIG. 8 compensates for both the surge and the flyback of the individual inverter, any number of inverters may be added up to the maximum operating current of the switch without deleterious surge and/or arcing. Likewise, an inverter as in FIG. 10 produces no significant potentials to the switch, and thus the sum of the inverter surge or flyback will be negligible. If arc suppressive inverters are used in a lighting system, it is expected that standard AC rated residential or industrial switches may be reliably used without loss of switch life over equivalent AC lighting system applications.

FIG. 11 illustrates one rectifier circuit that may be used for disclosed direct current distribution lighting systems. A power source 1100 supplies three-phase alternating current on lines 1102a-c. In this example, power source 1100 supplies 120VAC on each leg. That power is selectively delivered to six diodes 1104a-f, as illustrated, by way of three-pole switch 1100. The power may be distributed elsewhere as desired to other rectifiers, lighting systems, or other loads. Diodes 1104a-f rectify the AC power to DC power available at terminals 1106p and 1106n, which in this example, under load, might be about 140 positive and negative with respect to the average potential of the AC power. This circuit has the advantage of not requiring many components, which reduces the cost and improves the maintainability of the rectifier. Additionally it has a high power factor of about 95 percent and produces direct current without large ripple without the need of a large electrolytic reservoir capacitor, which also improves both the cost and the lifespan of the device. This rectifier additionally theoretically causes no third harmonic distortion of the input current waveform, which may cause overloading of the neutral conductor in lighting applications. This rectifier also has the benefit of applying a balanced load to the three phase source, and can continue to operate should one phase fail.

In a preferred rectifier system, rectifiers are installed in pairs. For each pair one rectifier has a delta primary and delta secondary, or Y primary and Y secondary configuration. The other rectifier of the pair has a delta primary and Y secondary, or Y primary and delta secondary configuration. Provided the loads are the same on the two rectifiers, this rectifier configuration has the effect of canceling the 5^{th} and 7^{th} harmonics of the AC input current, which raises the power factor of the system to about 99 percent.

A rectifier may additionally include line voltage surge protection equipment, which is cost effective due to the small number of rectifiers per installation. Other rectifier configurations may be used as desired in the disclosed systems, given sufficient filtering for necessary and desirable operation of a lighting system.

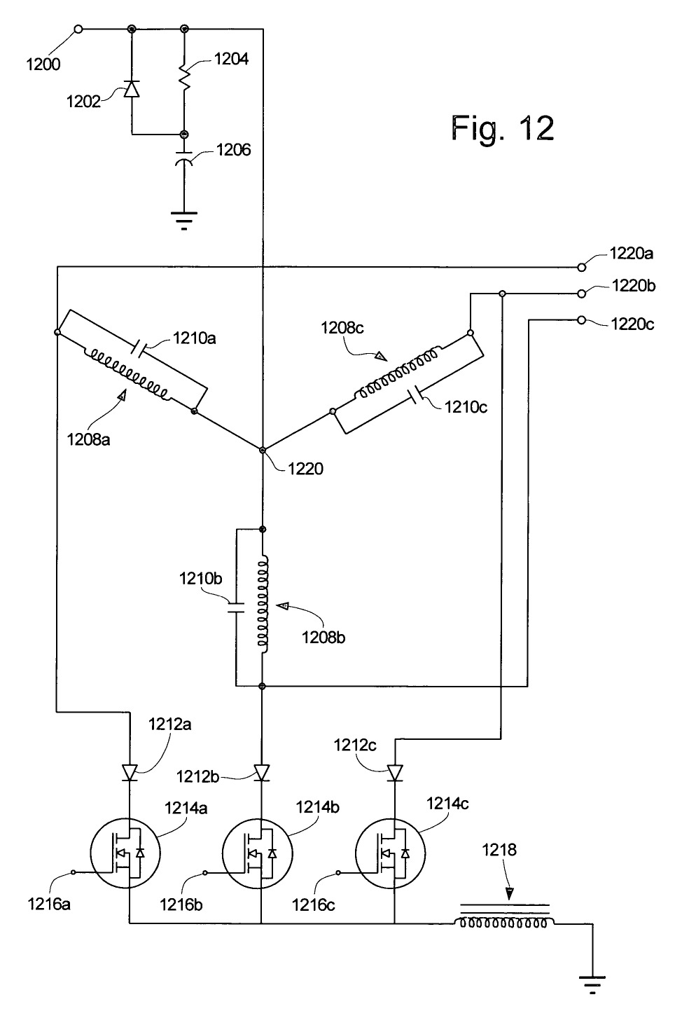

FIG. 12 illustrates an alternate inverter circuit that may be used under some circumstances. DC power is applied between positive terminal 1200 and a ground terminal, not shown. An anti-arc circuit is included through diode 1202, resistor 1204, and capacitor 1206, which operates as described earlier. A Y connected transformer is formed by windings 1208a-c, with capacitors 1210a-c preferably being included as tuned elements to produce a sinusoidal wave at the output terminals 1220a-c. Windings 1208a-c are preferably wound on a common core, as opposed to being separate inductors, to permit a degree of coupling or load sharing between the phases such that balanced loading is not strictly necessary. Windings 1208a-c may connect directly to delta-connected loads, which would further contribute to load sharing and may have the additional benefit of suppressing spurious voltage spikes. Diodes 1212a-c are included to protect transistors 1216a-c and to otherwise ensure a one-way current flow through each transistor sub-circuit. Transistors 1216a-c are MOSFET transistors which provide means for energizing inductors 1208a-c, control being supplied by a timing circuit through gates 1216a-c. Bi-polar transistors or other switching devices may be used, although the use of these may decrease efficiency and inverter heating through a larger apparent series resistance. Timing circuit may generally be configured to provide a square wave to the gates, each square wave being offset by 120 degrees in phase from the others. In a preferred timing, each transistor has a duty cycle of about 33%. In that timing each transistor turns on when the voltage across its load is at or near the peak value, to deliver the maximum possible energy with minimum transistor heating. In another example timing, the duty cycle is maintained at up to 50% to maximize the current delivered to the ballast loads at the expense of some efficiency and heating. The chosen timing should not permit all three switching devices to be off at the same time, maintaining the current in inductor 1218. Inductor 1218 provides means for regulating the current through the circuit, by which noise may be kept out of the supply and out of potentially transmitting wires and cables of the lighting system.

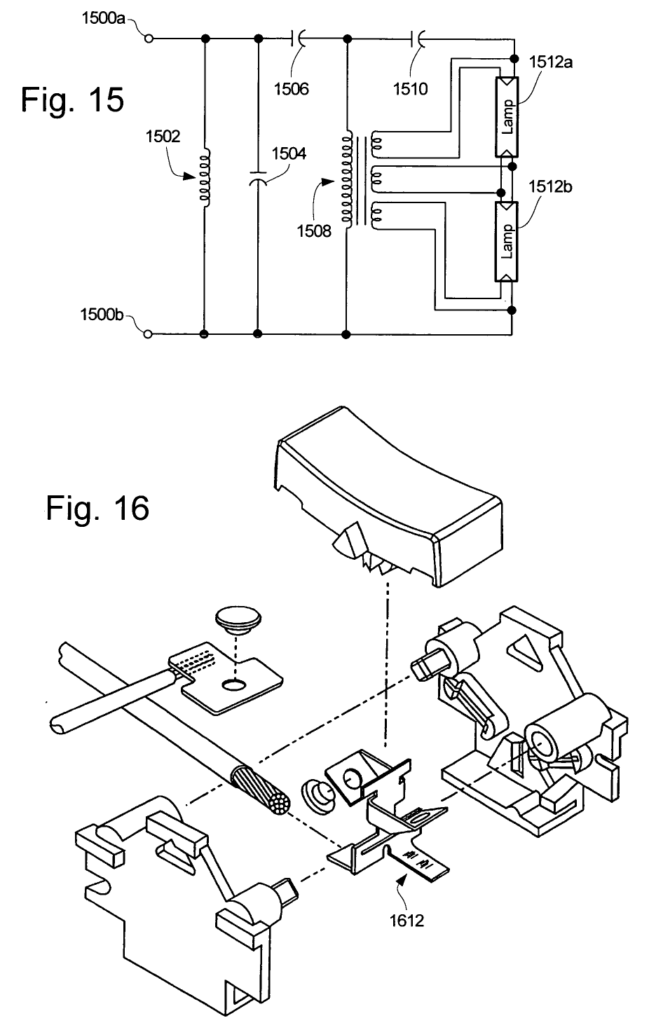

The circuit of FIG. 12 may provide high-frequency power, for example, to six 2-lamp ballasts. Its operation is similar to that of the familiar push-pull inverter, but with several important advantages. Most importantly, the overall Q, or quality factor, or ratio of reactive load to resistive load, may be maintained essentially constant regardless of the number of lamps driven. This may be acheived by placing most of the reactive load in the ballast packages, and example of such a ballast being illustrated in FIG. 14 and more especially in FIG. 15. Additionally, the heat of the system, which is generated primarily in the inductive elements, is dispersed to the ballast units where there is ample room for sufficiently large inductors and whereby heat may be kept out of the inverter package. The ballasts may be connected to output terminals 1220a-c in a Y or delta configuration, as desired, through the cabling system from the inverter to the ballasts and/or lamp fixtures. Ballasts in a delta configuration may suppress third harmonic components of the inverter output and further reduce peak transistor voltage, reduce radiated noise and improve lamp current crest factor. A ballast additionally preferably includes an isolation transformer, in addition to a ballast capacitor or inductor, for safety and suppression of radio frequency noise.

Inductor 1218 has traditionally been placed in series with the positive input line, and may optionally be moved to that location in the circuit of FIG. 12. In this example, the inductor is placed in series with the negative line, which allows the input to the center tap 1220 to be at AC ground potential, thus causing the drains and heat sinks of the transistors and the long lines leading therefrom to all be balanced to ground. This balancing tends to eliminate the radiation of first-order radio noise, and further allows the transformer secondary windings to be remotely located by which the inverter may be compressed into an unusually small package. Other inverter circuits may provide a similar AC ground by providing a connection from the common connection of the switched inductors to the power source or other AC ground at frequencies near the drive frequency and significant harmonics. This might be done, for example, in the inverter of FIG. 5 by moving inductor 76 in series with emitters 48 and 51 and terminal 42. The direct coupling need not be made through a direct connection, but might also be made through a filter network.

The inverter of FIG. 12 is driven by a timed control circuit, which preferably might be, for example, a microcontroller, a timing chip such as the LM555, or other logic device. In a preferred inverter of FIG. 12, the gates of transistors 1216a-c are initially driven so that all transistors are off for a period of time after the circuit is first powered. During this delay the switch contacts may settle, thus preventing circuit energizing arcing events.

The inverter as shown in FIG. 12 utilizes an output driven directly from windings 1208a-c. If desired, the transformer formed by windings 1208a-c may include secondary windings and terminals for driving a ballast load therefrom. This configuration may be particularly helpful if it is desired to drive the ballasts at a different voltage than that supplied at DC power input terminal 1200.

Now the inverter of FIG. 12 is a significant improvement over prior inverters, because it can drive multiple ballast units rather than only one. It additionally contains long life components, and avoids the use of electrolytic capacitors. Because gating action of the transistors occurs more frequently, a smaller inductor 1218 can be used to achieve filtering to that of the two-transistor inverter. In addition, that inverter has quiet acoustic and radio noise characteristics, and can be manufactured to efficiently drive appropriately designed ballast loads, as described below.

The disclosed rectifiers supplying multiple inverters or lighting circuits, and the inverters disclosed to receive DC power may be approach capital type equipment in reliability. As such, these inverters are preferably installed separately from consumable type equipment, such as lamps in lighting fixtures. Inverters having a long life span may therefore be placed in less conveniently accessible locations, for example in maintenance alcoves and closets, which may simplify maintenance of a lighting system by leaving the maintainable components accessible as a group. Inverters are preferred to be installed in proximity to their corresponding ballast loads, to minimize high frequency losses in connecting cables. Systems with separate rectifiers and inverters further simplify the lighting fixture equipment, which reduces the cost of this equipment and generally makes the system less expensive to install. If desired, an inverter can be mounted in or locally to a fixture to reduce the number of logical components in a lighting installation.

The preferred number of fixtures driven per inverter will depend on a number of factors. It may be desirable to supply as many fixtures as an inverter can efficiently and reliably drive, so as to reduce the number of inverters needed in a lighting system. On the other hand, an increased number of inverters permits redundancy in a lighting system, which permits lighting to continue should an inverter fail. It is expected that in many circumstances, two inverters per lighting space will be desirable for that reason. It is also desirable to provide a standard inverter product usable for most circumstances, capable of driving all or a portion of an ordinary sized room. Through disclosed inverter designs, an inverter product may be made having a size comparable to common AC ballasts, but capable of driving a larger number of lamps, for example up to 12 lamps. Because these inverters do not include a full transformer or large electrolytic reservoir capacitor, inverters capable of driving many lamps may be enclosed in a package of small size, includable in a common-sized lighting fixture. An inverter capable of driving 12 lamps is desirable, as it might be conveniently configured to drive an even divisor of 12 lamps. Likewise, a three phase inverter capable of driving 12 lamps might supply 3, 6, 9 or 12 lamps through 3 or 6 ballasts, while maintaining a balanced load on the high frequency drive. Such inverter products may be installed maximally or partially loaded, depending on the application requirements as dictated by building floorplans and other considerations.

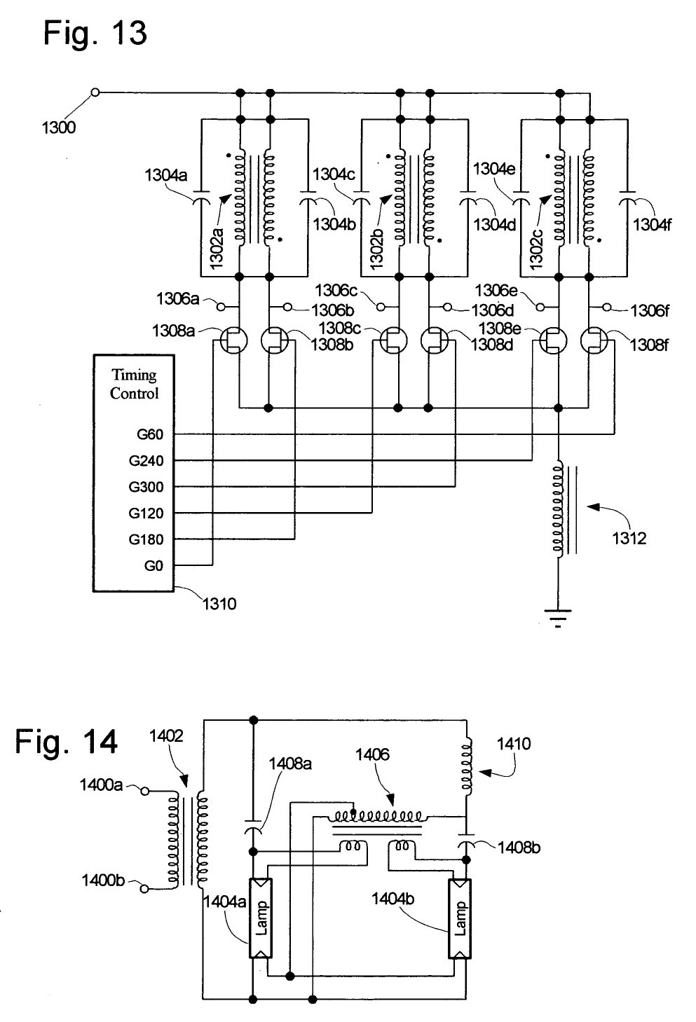

FIG. 13 depicts a more complex implementation of an inverter adhering to the principles of operation of FIG. 12. Positive DC power is supplied at terminal 1300, which may flow through the windings of transformers 1302a-c, as gated through transistors 1308a-f. In this circuit there are six windings thus six drive transistors. This circuit may be used to supply a larger number of ballasts and/or a larger load. Additionally, this circuit may be further helpful to suppress load noise on the power supply as well as radio noise.

FIG. 14 depicts a ballast that may be driven by inverters, disclosed and otherwise. An isolation transformer 1402 is fed at primary terminals 1400a and 1400b. Capacitors 1408a and 1408b, and inductor 1410 provide the ballast load, and additionally prevent the rectification of AC current through the circuit by a failing lamp. Transformer 1406 provides drive for the heating elements of lamps 1404a and 1404b at a reduced voltage.

FIG. 15 depicts another ballast, usable in disclosed systems and elsewhere. AC power is applied at terminals 1500a and 1500b. Inductor 1502 and capacitor 1504 provide a known reactance and Q to the circuit, as seen by the driving inverter. Capacitor 1510 provides protection against rectification of the AC input, should either of lamps 1512a or 1512b fail due to cathode erosion. Transformer 1508 provides a lower voltage source to drive the heating elements of lamps 1512a and 1512b. Capacitor 1506 blocks any DC current from flowing into transformer 1508. This ballast is particularly well suited for use with inverters capable of supplying power to more than one ballast, for example the inverters of the type of FIG. 12. Such an inverter may drive one, two, three or more ballast loads, while maintaining the same Q factor regardless of the number of ballast units. The ballasts of FIGS. 14 and 15 may be driven by a single phase inverter, such as depicted in FIG. 5, or by a poly-phase inverter, as depicted in FIGS. 12 and 13. Those ballasts are superior to other ballasts, in that they contain only a few passive and long-lasting components, and no semiconductors or electrolytic capacitors, which leads to improved maintainability and service life.

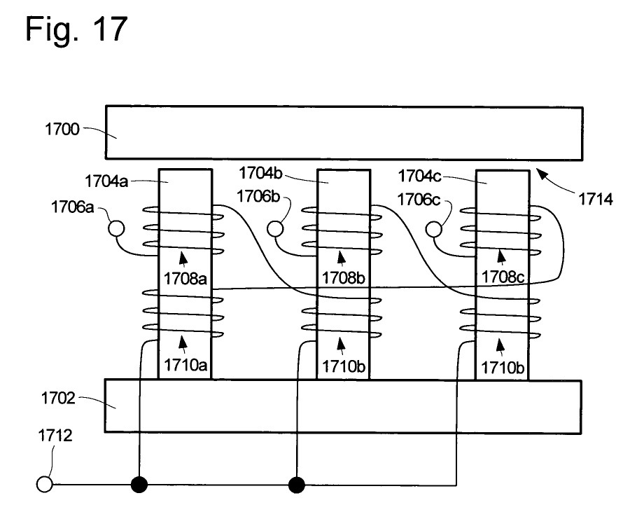

Depicted in FIG. 17 is a transformer configuration that may be advantageously used in systems disclosed herein and otherwise, and more particularly useful in a poly-phase inverter of the type depicted in FIG. 12. A transformer core is formed on three rods 1704a-c, and capped by plates 1700 and 1702 through one of several methods known in the art. The transformer core may be fashioned from ferrite or non-ferrite materials, depending on the desired transformer characteristics. A gap 1714 is preferably maintained between rods 1704a-c and one of plates 1700 and 1702 to store inductive energy. Although rods 1704a-c are depicted as arranged in a straight line (when looking from the top), rods 1704a-c may be positioned in a triangular arrangement to provide similar flux paths, compactness and efficient wire winding, with plates 1700 and 1702 taking a circular or triangular shape. Three windings are wound on rods 1704a-c, each winding comprising two half-windings placed on differing rods. For example, half-winding 1708a placed on rod 1704a and half-winding 1710a placed on rod 1704b form a complete zig-zag winding. For each winding, the two half-windings are wound in opposite directions, thereby creating opposing flux directions in two of rods 1704a-c. In theory, the opposing flux directions cancel out at times when the windings on any particular rod are energized, thereby reducing core losses and increasing transformer efficiency. Each winding is electrically attachable at ends 1706a-c to a load or other connection. In this example, the three windings are tied in common and made available to a terminal or pin 1712. Additional windings may be placed on such a transformer core as desired.

While gas-discharge lighting systems having a direct current distribution and switching and the use thereof have been described and illustrated in conjunction with a number of specific configurations and methods, those skilled in the art will appreciate that variations and modifications may be made without departing from the principles herein illustrated, described, and claimed. The above disclosure speaks of inductors, capacitors, resistors, switches and other components; it is to be understood that the term components encompasses not only unitary components by these specific names, but also other components and combinations of components that serve an equivalent function. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

1. A gas-discharge lamp inverter for use in a direct current distribution lighting system, said inverter having an arc suppressing feature for suppressing the arc in an electrically connected switch, comprising:
at least two power connecting points for electrically connecting a direct current power source, said power connecting points including a positive point and a negative point;
at least two output connecting points for providing an alternating current;
an oscillating drive circuit for producing the alternating current at the output connecting points, the alternating current produced being suitable for driving at least one ballast and at least one gas-discharge lamp in combination;
a constant current component capable of providing or sinking a constant current to said oscillating drive circuit when the inverter is energized by power provided at said power connecting points;
whereby the inverter has an arc suppressing characteristic, that arc suppressing characteristic providing arc suppression for both energizing and de-energizing events.

2. The inverter of claim 1, wherein the inverter comprises:
a biasing component providing clamping across said power connecting points, such that said positive point is prevented from having a substantial negative potential relative to said negative point after a de-energizing event.

3. The inverter of claim 1, wherein the inverter comprises:
an inductive component electrically connected in series with said oscillating drive circuit, said inductive component configured to reduce in-rush current to the oscillating drive circuit at the time of inverter energizing;
a capacitive component in series with a resistive component, both electrically connected to said positive point and said negative point, whereby the capacitive component may receive a charge through said resistive componentat a controlled rate when said inverter is energized;
a biasing component connected to said capacitive component controlling the discharge of the capacitive component, said biasing component configured such that a charge is delivered to said inductive componentat the time of inverter de-energizing.

4. The inverter of claim 3, wherein the inverter comprises a second biasing component providing clamping across said power connecting points, such that said positive point is prevented from having a substantial negative potential relative to said negative point after a de-energizing event.

5. The inverter of claim 3 having reduced radio emissions, wherein:
the oscillating drive circuit includes a plurality of inductive components, said inductive components having a common connection point;
and wherein the common connection point is coupled to ground through a connection from the common connection of the switched inductors to an AC ground at frequencies near the drive frequency and significant harmonics.

6. A system according to claim 1, further comprising:
a switch electrically connected to at least one power connecting point, said switch configured to provide interruption and control of current to said inverter such that said inverter may be energized and de-energized;
and wherein said inverter comprises means for slowing the rate of voltage drop at said positive point to an effective amount to prevent arcing in said switch when said switch is opened.

7. A system according to claim 6, wherein said inverter further comprises means for preventing the voltage of said positive point from dropping substantially below the voltage of said negative point when said switch is opened.

8. An inverter according to claim 1, wherein the oscillating drive circuit comprises:
three switching components;
three inductive components controllable by said switching components, said inductive components configured to produce three phase output; and
three output points forming an electrical connectable feature for providing the three phase output.

9. A system according to claim 1, further comprising:
a plurality of fixtures, each of said fixtures locally connected to at least one ballast, each of said fixtures further including provision for mounting at least one gas discharge lamp; and
wherein at least one of said inverters is connected to drive a plurality of said ballasts.

10. A system according to claim 1, further comprising a lighting fixture attached to said inverter, said lighting fixture having a ballast, said lighting fixture further having mountings whereby a number of gas-discharge lamps may be connected to said ballast, wherein:
said inverter is of a compact size suitable for attachment to said lighting fixture; and
said inverter is capable of driving the ballast in combination with a full set of connected lamps and at least one ballast of a separate fixture.

11. A fluorescent lighting system utilizing a direct current distribution system, the lighting system having arc suppression for long switch life, the system comprising:
a source of direct current power;
at least one lighting circuit, each lighting circuit comprising a switch and at least one inverter, further in each circuit the switch being electrically connected to each of said inverters to interrupt and control the power to the inverters such that the inverters may be energized and de-energized, each of said inverters comprising (i) a direct current input, (ii) an alternating current output, (iii) an oscillating drive circuit for producing the alternating current at the inverter output, the alternating current produced being suitable for driving at least one ballast and at least one gas-discharge lamp in combination, and (iv) a constant current component capable of providing or sinking a constant current to said oscillating drive circuit when said inverter is energized by power provided at said inverter input, whereby each of said inverters has an arc suppressing characteristic, that arc suppressing characteristic providing arc suppression for both energizing and de-energizing events; and
a distribution network distributing the direct current power from said source to each of said lighting circuits.

12. The system of claim 11, wherein each inverter comprises:
a biasing component providing clamping across said power connecting points, such that said positive point is prevented from having a substantial negative potential relative to said negative point after a de-energizing event.

13. The system of claim 11, wherein each inverter comprises:
an inductive component electrically connected in series with said oscillating drive circuit, said inductive component configured to reduce in-rush current to the oscillating drive circuit at the time of inverter energizing;
a capacitive component in series with a resistive component, both electrically connected to said positive point and said negative point, whereby the capacitive component may receive a charge through said resistive componentat a controlled rate when said inverter is energized;
a biasing component connected to said capacitive component controlling the discharge of the capacitive component, said biasing component configured such that a charge is delivered to said inductive component at the time of inverter de-energizing.

14. The system of claim 12, wherein each inverter comprises:
a second biasing component providing clamping across said power connecting points, such that said positive point is prevented from having a substantial negative potential relative to said negative point after a de-energizing event.

15. A system according to claim 11, wherein each of said inverters comprises means for slowing the rate of voltage drop at said positive point to an effective amount to prevent arcing when one of said switches is opened.

16. A system according to claim 15, wherein each of said inverters further comprises means for preventing the voltage of said positive point from dropping substantially below the voltage of said negative point when said inverter is de-energized.

17. A system according to claim 11, wherein at least one oscillating drive circuits comprises:
three switching components;
three inductive components controllable by said switching components; and
three output points forming an electrical connectable feature for providing three phase output.

18. A system according to claim 11, further comprising:
at least one ballast connected to one of said inverters, each of said ballasts configured to provide a substantially constant Q to said inverters, wherein the Q as seen by the inverter does not depend on the number of said ballasts connected.

19. A system according to claim 11, further comprising an alternative direct current power source.

20. A system according to claim 11, wherein said source of direct current power comprises a rectifier, said rectifier capable of receiving at the input three phase power.
